(19) United States
(12) Patent Application Publication
(10) Pub. No.: US 2026/0159003 A1
(43) Pub. Date: Jun. 11, 2026

(54) Work Vehicle and Seat Arrangement

(71) Applicant: Kubota Corporation, Osaka-shi (JP)

(72) Inventor: Yusuke Endo, Sakai-shi (JP)

(21) Appl. No.: 19/180,207

(22) Filed: Apr. 16, 2025

(30) Foreign Application Priority Data
Apr. 25, 2024 (JP) 2024-071650

(51) Int. Cl. B60R 7/04; B60N 2/90

(52) U.S. Cl. CPC B60R 7/043; B60N 2/90

(57) ABSTRACT

A work vehicle includes a body with a seat arrangement for an occupant to seat on. The seat arrangement includes a seat base and a seat support supporting the seat base. The seat base is swingable about an axis which is located in a front part or a rear part of the seat base and extends in a width direction of the seat base. The seat base is switchable between a use orientation in which a seating face of the seat base faces upward and an inverted orientation in which the seating face of the seat base faces downward, and in the inverted orientation, an upper portion of the seat support is exposed.

This application claims priority to Japanese Patent Application No. 2024-071650 filed April 25, 2024, the disclosure of which is hereby incorporated by reference in its entirety.

### BACKGROUND OF THE INVENTION

### Field of the Invention

The present invention relates to a work vehicle and a seat arrangement.

### Description of the Related Art

Japanese Patent Application Publication No. 2016-094133 (JP 2016-094133) discloses a utility vehicle having a driver’s seat and a passenger’s seat, in which a seating part of at least one of the seats is swung up about an axis extending in a front lower portion or a rear lower portion of the seating part to expose an upper portion of a container space provided under the driver’s seat or the passenger’s seat, for placing or removing an object in or from the container.

When the upper portion of the container space is exposed, the seating part extends perpendicularly to a floor of a driver section. In this state, an upper face of the seating part above the seating face has a smaller surface area than the surface area of the seating face.

As described above, when the upper portion of the container space in JP2016-094133A is exposed, the upper face of the seating part above the seating face has a surface area smaller than the surface area of the seating face. As a result, in a state where the upper portion of the container space is exposed, it is difficult to stably place an object or the like on the upper face of the seating part, as compared with the seating face or a face opposite to the seating face of the seating part.

### SUMMARY OF THE INVENTION

The present invention provides a work vehicle and a seat arrangement in which an object can be stably and easily placed on the seating part while an upper portion of the seat support is exposed.

The work vehicle of the present invention includes a body with a seat arrangement for an occupant to seat on, the seat arrangement including: a seat base; and a seat support supporting the seat base, wherein the seat base is swingable about an axis which is located in a front part or a rear part of the seat base and extends in a width direction of the seat base, the seat base being switchable between a use orientation in which a seating face of the seat base faces upward and an inverted orientation in which the seating face of the seat base faces downward, and with the seat base in the inverted orientation, an upper portion of the seat support is exposed.

With this configuration, the seating face of the seat base in the inverted orientation faces downward, and thus an object can be easily and stably placed on an opposite face of the seat base which is opposite to the seating face.

In the present invention, the seat base may include: an opening for ventilation in an end portion on a side opposite to a position of the axis in a front-rear direction; and a bracket above the opening of the seat base in the inverted orientation, and swing of the seat base is limited by the bracket being brought into contact with the body.

With this configuration, the swing of the seat base is stopped at a given position by the bracket. In addition, the bracket is above the opening of the seat base in the inverted orientation, and thus rain or the like is prevented from entering the opening.

In the present invention, the seat base has an end portion on a side of the axis in a front-rear direction, and swing of the seat base may be limited by the end portion of the seat base being brought into contact with the seat support.

With this configuration, the number of parts can be kept as small as possible, while the swing of the seat base can be limited with a simple configuration.

In the present invention, the seat base may have an opposite face which is opposite to the seating face, and in the use orientation, the seat base may be mounted on an upper face of the seat support, and in the inverted orientation, the upper face of the seat support may be flush with the opposite face.

With this configuration, when the seat base is in the inverted orientation, the upper face of the seat support is flush with the opposite face, and thus an object can be easily placed in a space for object provided by the seat support and the seat base.

In the present invention, the seat support may include an object container receding downward from an upper face of the seat support.

With this configuration, an object can be placed in the object container receding downward from the upper face of the seat support. As a result, even when the work vehicle jolts, the object is unlikely to fall off from the seat base as compared with a case where the object is placed directly on the upper face of the seat support.

In the present invention, the work vehicle may further include an occupant section for passengers, wherein the occupant section includes: a driver’s seat for a driver; and a rear seat, as the seat arrangement, rearward of the driver’s seat, and the rear seat has a width at least twice a width of the driver’s seat.

With this configuration, when the seat base is in the inverted orientation, an object or the like can be easily and stably placed on the opposite face of the seat base having a width at least twice the width of the driver’s seat. In other words, in the inverted orientation, a broader space for mounting objects can be secured above the seat base.

The seat arrangement of the present invention includes: a seat base for an occupant to seat on; and a seat support supporting the seat base, wherein the seat base is swingable about an axis which is located in a front part or a rear part of the seat base and extends in a width direction of the seat base, the seat base being switchable between a use orientation in which a seating face of the seat base faces upward and an inverted orientation in which the seating face of the seat base faces downward, and with the seat base in the inverted orientation, an upper portion of the seat support is exposed.

With this configuration, when the seat base is in the inverted orientation, the seating face of the seat base faces downward, and thus an object or the like can be easily and stably placed on the opposite face.

### BRIEF DESCRIPTION OF THE DRAWINGS

FIG. 1 is a right side view of a work vehicle.

FIG. 2 is a horizontal sectional plan view of an occupant section.

FIG. 3 is a vertical sectional right side view of a rear seat with a seat base in a use orientation.

FIG. 4 is a horizontal sectional plan view of the rear seat with the seat base in the use orientation.

FIG. 5 is a perspective view showing a structure of a seat base.

FIG. 6 is a vertical sectional right side view of the rear seat with the seat base in an inverted orientation.

FIG. 7 is a horizontal sectional plan view of the rear seat with the seat base in the inverted orientation.

### DESCRIPTION OF THE INVENTION

As one embodiment of the work vehicle according to the present invention, a utility vehicle will be described below with reference to the drawings.

In the following description, with respect to a body of the utility vehicle, a side indicated by an arrow F in the drawings is a “front” side of the body, a side indicated by an arrow B in the drawings is a “rear” side of the body, a side indicated by an arrow U in the drawings is an “upper” side of the body, a side indicated by an arrow D in the drawings is a “lower” side of the body, a side indicated by an arrow L in the drawings is a “left” side of the body, and a side indicated by an arrow R in the drawings is a “right” side of the body. A right-left direction of the body corresponds to a transversal direction of the body, and may also be referred to as a “width” direction or a “lateral” direction of the body. A front-rear direction of the body corresponds to a longitudinal direction of the body.

### Entire structure

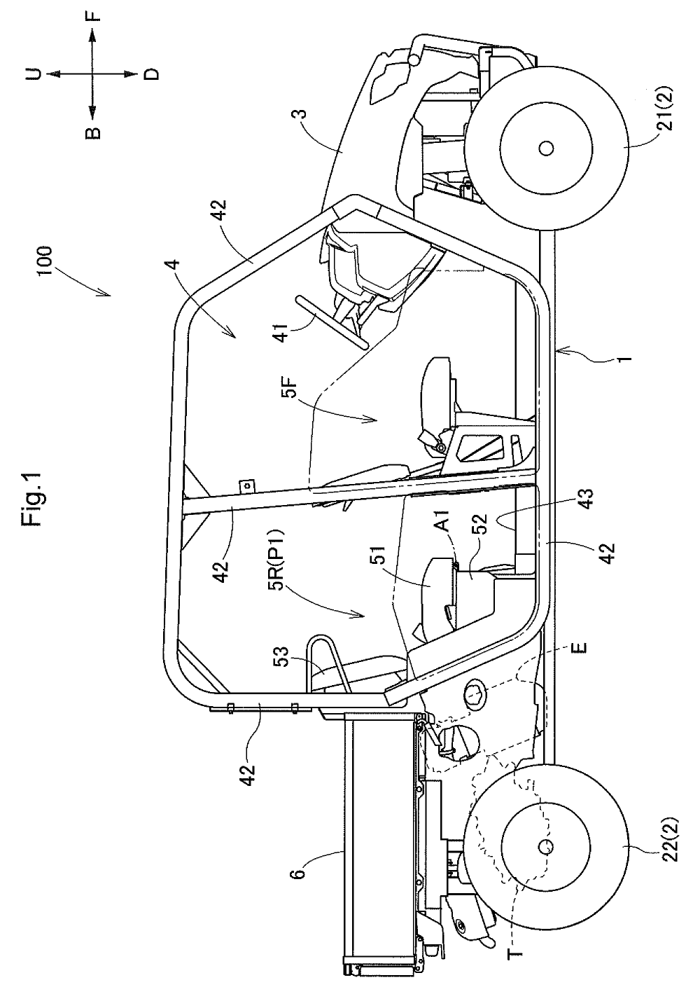

As shown in FIG. 1, a work vehicle has a body 100 which includes: a body frame 1; a travel device 2 supporting the body frame 1; a hood 3 (bonnet); an occupant section 4 for passengers to board; a dump type cargo bed 6; and an engine E.

The travel device 2 includes right and left front wheels 21 which are steerable (turnable) and drivable, and right and left rear wheels 22 which are non-steerable and drivable. The front wheels 21 support a front part of the body frame 1. The rear wheels 22 support a rear part of the body frame 1. The travel device 2 is switchable between a two-wheel drive state in which only the right and left rear wheels 22 are driven, and a four-wheel drive state in which the right and left front wheels 21 and the right and left rear wheels 22 are driven.

The occupant section 4 is between the front wheels 21 and the rear wheels 22 as viewed from a lateral side. The occupant section 4 is supported by the body frame 1.

The hood 3 is forward of the occupant section 4. The cargo bed 6 is rearward of the occupant section 4. Under the hood 3, a radiator to cool a coolant for the engine E and the like are disposed.

A motive power from the engine E is changed by a transmission T and the changed motive power is transmitted to the front wheels 21 or the rear wheels 22. The engine E and the transmission T are below the cargo bed 6.

### Occupant section

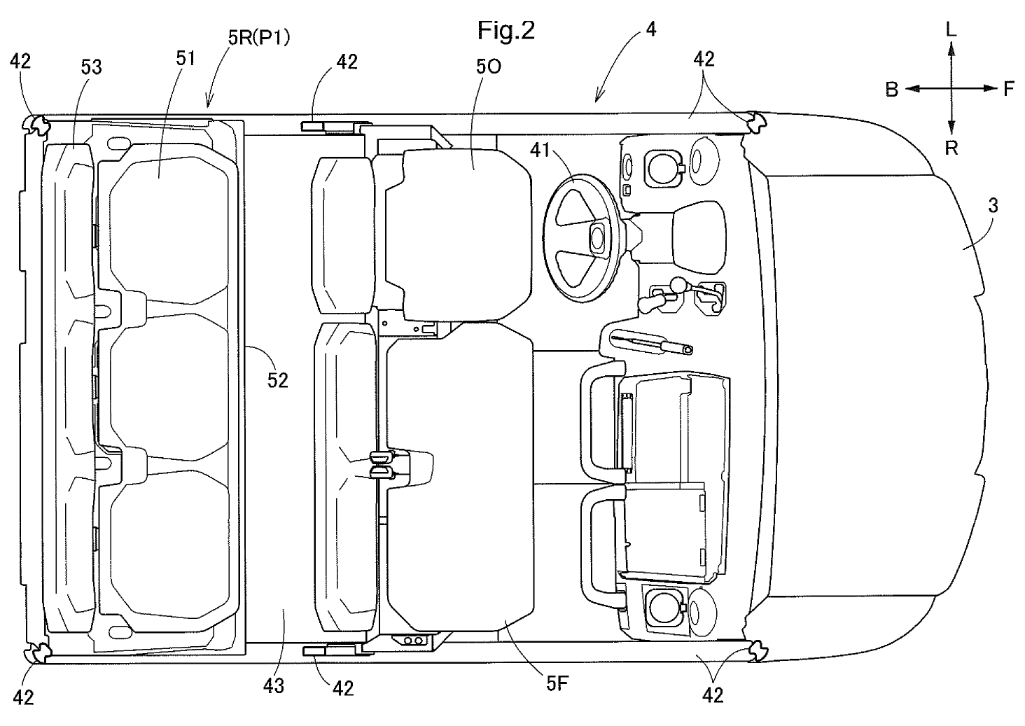

As shown in FIGS. 1 and 2, the occupant section 4 includes: a steering wheel 41 for steering and operating the right and left front wheels 21; a ROPS (Rollover Protective Structure) 42 for protecting the occupants; a floor panel 43 serving as a floor face of the occupant section 4; and various operation tools, such as gear shift lever for gear change operation.

The occupant section 4 includes: a driver’s seat 5O for a driver; a front seat 5F for a passenger, disposed on a lateral side of the driver’s seat 5O; and a rear seat 5R (corresponding to “seat arrangement”) rearward of the driver’s seat 5O and the front seat 5F.

The rear seat 5R has a width at least twice a width of the driver’s seat 5O. In the present embodiment, the rear seat 5R has a width three times the width of the driver’s seat 5O. In other words, the driver’s seat 5O is for one occupant, while the rear seat 5R is for three occupants. The present invention is not limited to this embodiment, and the rear seat 5R may have a width twice the width of the driver’s seat 5O.

The driver’s seat 5O is rearward of the steering wheel 41.

The ROPS 42, including the right and left ROPS sections, surrounds the occupant section 4. The ROPS 42 is connected to the body frame 1 and surrounds the driver’s seat 5O, the front seat 5F and the rear seat 5R.

The floor panel 43 is supported by the body frame 1.

### Rear seat

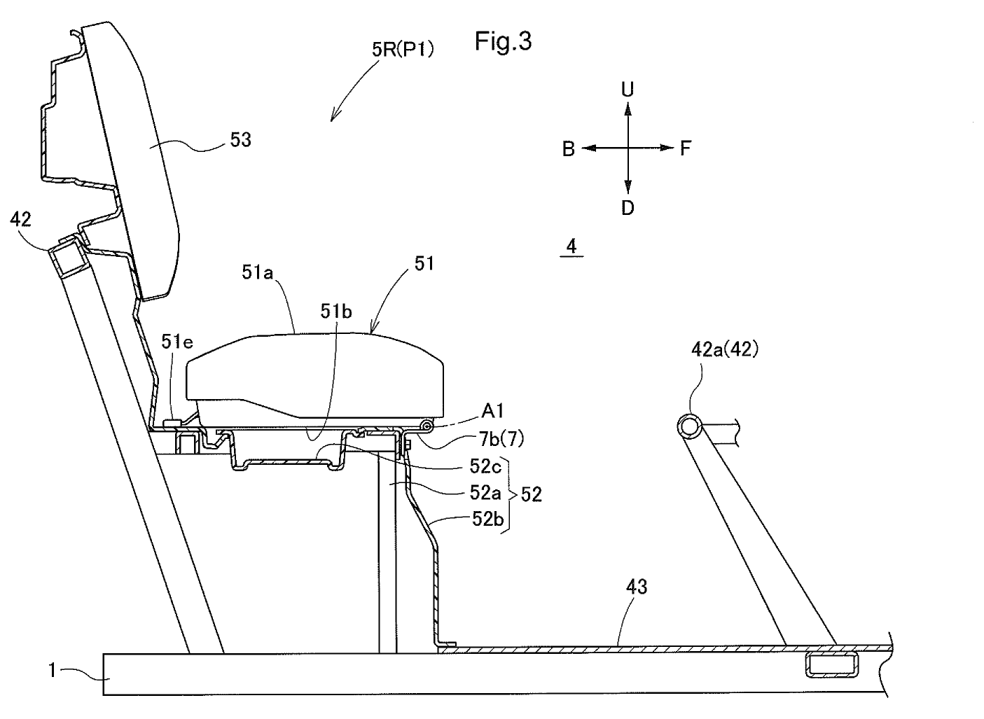

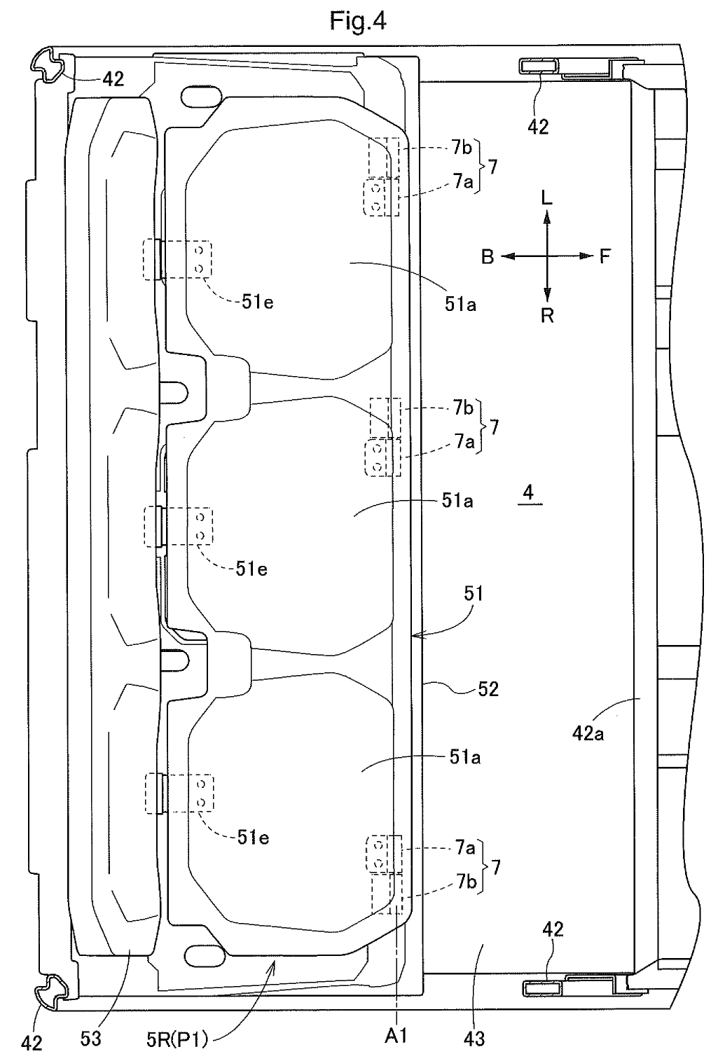

As shown in FIGS. 3 and 4, the rear seat 5R includes: a seat base 51 for an occupant to sit on; a seat support 52 supporting the seat base 51; and a seat back 53 rearward of the seat base 51. The seat back 53 is fixed to the right and left ROPS sections.

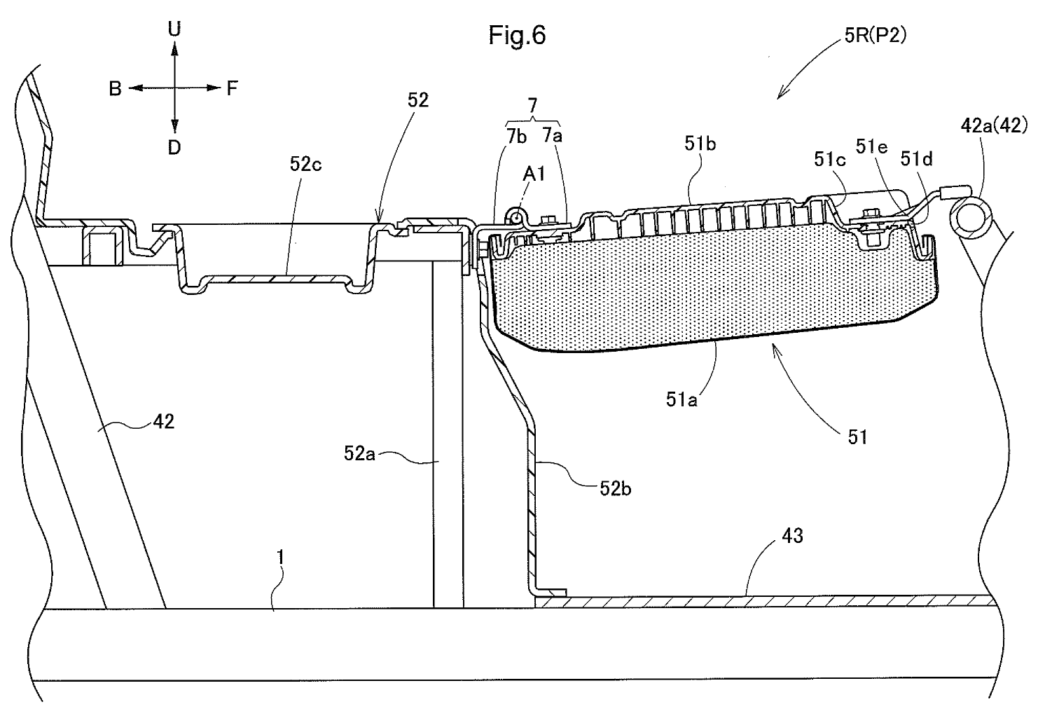

In the rear seat 5R, an axis A1 extends in a width direction of the seat base 51 under a front part of the seat base 51. The seat base 51 is swingable about the axis A1, by which the seat base is switched between a use orientation P1 in which a seating face 51a of the seat base 51 faces upward and an inverted orientation P2 in which the seating face 51a of the seat base 51 faces downward (FIG. 6).

### Seat base

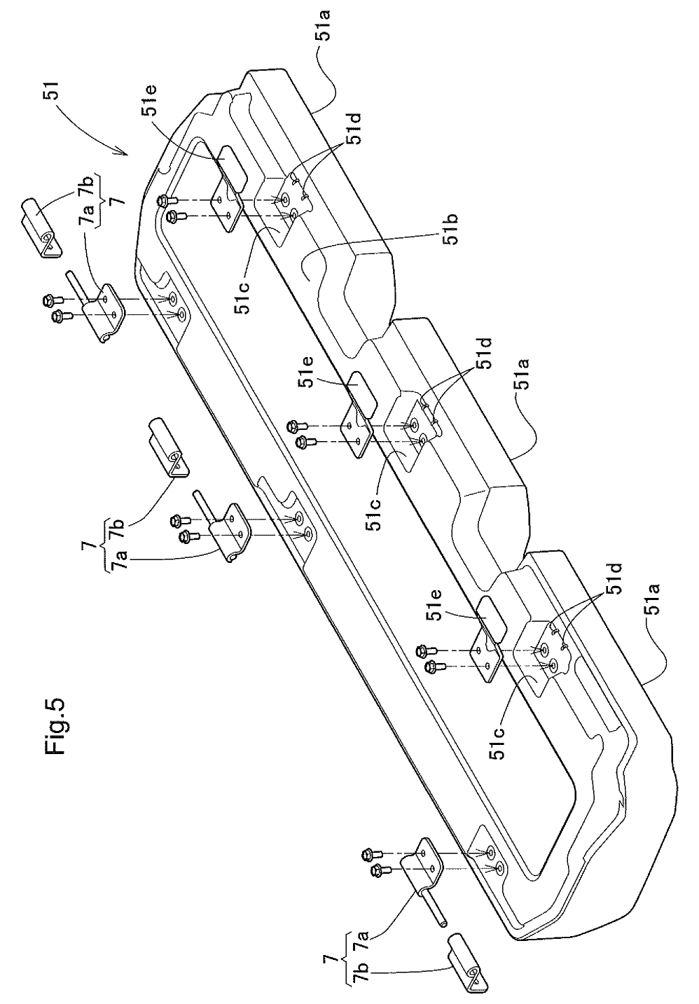

With reference to FIGS. 5, 6 and 7, the seat base 51 includes a water-repellent sheet member and foam, such as urethane foam, included in the sheet member. The sheet member is exposed on the seating face 51a of the seat base 51 and the seating face 51a has a cushioning property. At least an opposite face 51b which is opposite to the seating face 51a of the seat base 51 is covered with a resin cover.

The seat base 51 has: recesses 51c each extending from the opposite face 51b towards the seating face 51a; openings 51d for ventilation in an end portion of the seat base 51 which end portion is on a side opposite to a position of the axis A1 in a front-rear direction; and brackets 51e in a plate shape.

The recesses 51c are arranged in a front end portion of the opposite face 51b at intervals in the width direction of the seat base 51 in the inverted orientation P2. In the present embodiment, three recesses 51c are present. The number of the recesses 51c is not limited to three, and may be any number.

The opening 51d is for air ventilation for the foam inside the seat base 51. The openings 51d are formed in a bottom portion (when the seat base 51 is in the inverted orientation P2) of each of the recesses 51c. In the present embodiment, a front end portion of each recess 51c has two openings 51d. The number of the openings 51d in each recess 51c is not limited to two, and may be any number. Each opening 51d penetrates the resin cover on the opposite face 51b and is elongated from the opposite face 51b towards a front side face of the seat base 51 in the inverted orientation P2.

As shown in FIG. 6, the bracket 51e is above the opening 51d when the seat base 51 is in the inverted orientation P2. Each bracket 51e is fixed to the opposite face 51b by being secured to the bottom portion of each recess 51c by bolts. In other words, the brackets 51e are arranged at intervals in the width direction of the seat base 51, in the front end portion of the opposite face 51b when the seat base 51 is in the inverted orientation P2.

The bracket 51e (when the seat base 51 is in the inverted orientation P2) extends horizontally forward of the body 100, bends, and is inclined upward toward the front.

As shown in FIG. 5, the work vehicle includes hinges 7 swingably supporting the seat base 51. Each of the hinges 7 includes: a first member 7a fixed to the opposite face 51b; and a second member 7b fixed to a front face of the seat support 52. The first member 7a is swingable about the axis A1 relative to the second member 7b.

### Seat support

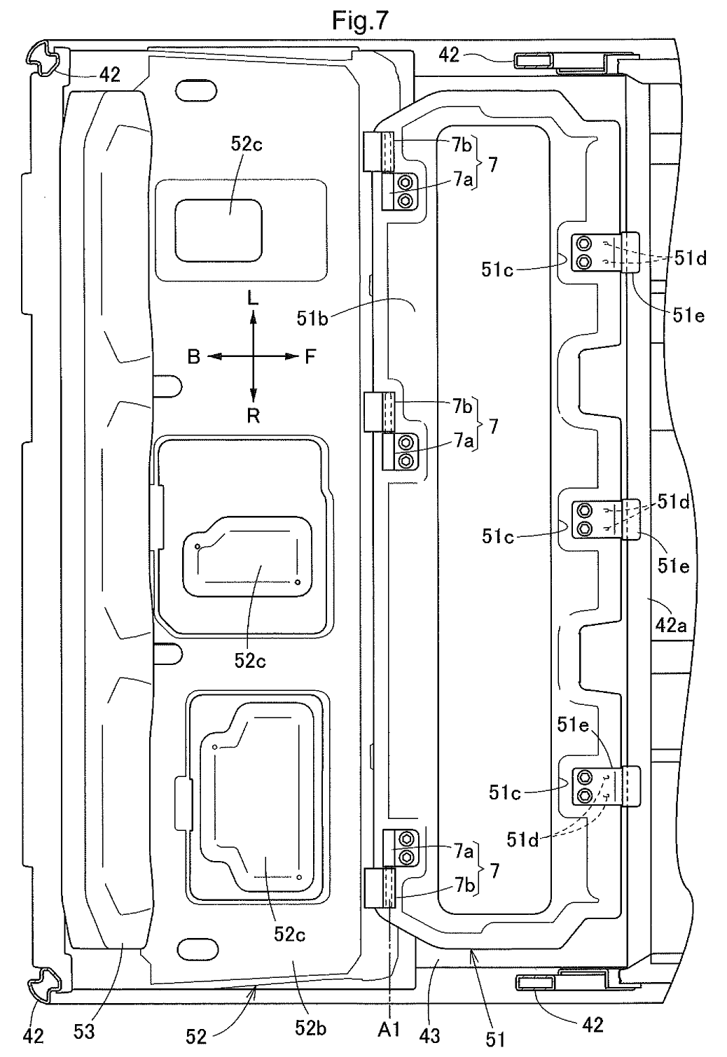

As shown in FIGS. 6 and 7, the seat support 52 includes: a seat support frame 52a supporting the seat base 51; a cover member 52b covering the seat support frame 52a; and object containers 52c receding downward from an upper face of the seat support 52.

The seat support frame 52a is supported by the body frame 1. The seat support frame 52a includes: standing frame sections extending upward from the body frame 1; and upper frame sections which are connected to upper end portions of the standing frame sections and arranged in a grid manner as viewed from above. The upper frame section extends in a width direction of the rear seat 5R.

The cover member 52b is molded from a resin sheet member. The cover member 52b covers the seat support frame 52a from above. The cover member 52b also covers the seat support frame 52a from the front. In other words, the cover member 52b serves as the upper face and the front face of the seat support 52.

In the upper face of the seat support 52, the object containers 52c are arranged at intervals in a width direction of the seat support 52.

### Orientation change of rear seat

As shown in FIG. 3, when the seat base 51 of the rear seat 5R is in the use orientation P1, the seat base 51 is mounted on the upper face of the seat support 52. In the use orientation P1, the seat base 51 is swingable about the axis A1 of the hinge 7 in a clockwise direction in FIG. 3.

In the use orientation P1, a rear part of the seat base 51 is lifted by manual operation and the seat base 51 is swung about the axis A1 in a clockwise direction in FIG. 3. As shown in FIG. 6, the swing of the seat base 51 is limited by each bracket 51e being brought into contact with a transversal frame 42a, which is a portion of the front seat 5F. The transversal frame 42a extends in a right-left direction between the right and left ROPS sections. In other words, the swing of the seat base 51 is stopped by the bracket 51e being brought into contact with the transversal frame 42a of the body 100. In addition, the swing of the seat base 51 is also limited by a rear end portion of the seat base 51 (in the inverted orientation P2, as shown in FIG. 6) on a side of the axis A1 in the front-rear direction being brought into contact with the front face of the seat support 52.

With this configuration, the rear seat 5R is brought into the inverted orientation P2. In the inverted orientation P2, an upper portion of the seat support 52 is exposed. In other words, in the inverted orientation P2, the seat base 51 does not overlap the upper face of the seat support 52 as viewed from above. Specifically, in the inverted orientation P2, the opposite face 51b is forward of the upper face of the seat support 52. In the inverted orientation P2, the upper face of the seat support 52 is flush with the opposite face 51b of the seat base 51. In other words, in the inverted orientation P2, a height position of the opposite face 51b is substantially equal to a height position of the upper face of the seat support 52. In the inverted orientation P2, an angle between the upper face of the seat support 52 and the opposite face 51b is approximately 180 degrees.

As shown above, in the inverted orientation P2, the seating face 51a faces downward. The term “downward” herein may include “downward and forward”, and “downward and rearward”.

### Other embodiments

The present invention is not limited to the above-mentioned embodiment. For example, the present invention may be configured as other embodiments shown below. In the other embodiments shown below, for the same components as described in the above embodiment, the same reference characters are used.

In the embodiment above, the seat base 51 of the rear seat 5R is switchable between the use orientation P1 and the inverted orientation P2. The present invention is not limited to this embodiment, and a seat base of the front seat 5F (corresponding to “seat arrangement”) may be switchable between the use orientation P1 and the inverted orientation P2. In other words, a seat base of at least one of the front seat 5F and the rear seat 5R may be switchable between the use orientation P1 and the inverted orientation P2.

In the embodiment above, the width of the rear seat 5R is at least twice the width of the driver’s seat 5O. The present invention is not limited to this embodiment, and the rear seat 5R may have a width equal to the width of the driver’s seat 5O. In other words, the rear seat 5R may be for one occupant.

In the embodiment above, in the rear seat 5R, the seat base 51 is swingable to a front side of the body 100 about the axis A1 extending in the front part of the seat base 51. The present invention is not limited to this embodiment, and in the rear seat 5R, the seat base may be swingable to a rear side of the body 100 about an axis extending in the rear part of the seat base 51. In this case, the rear seat 5R may not have the seat back 53.

In the embodiment above, the seat base 51 has the bracket 51e in the plate shape. The present invention is not limited to this embodiment, and the bracket 51e may be in other configurations. For example, the bracket 51e may be a member in a shape of an arm whose distal end portion is configured to come into contact with the transversal frame 42a.

In the embodiment above, the bracket 51e is in each recess 51c. The present invention is not limited to this embodiment, and the bracket 51e may be in a portion of the opposite face 51b other than the recess 51c.

In the embodiment above, the opening 51d is in the opposite face 51b. However, the present invention is not limited to this embodiment. The opening 51d may be in a front or rear face of the seat base 51 which face is on a side opposite to a position of the axis A1 in the front-rear direction.

In the embodiment above, the seat support 52 has the object container 52c receding downward from the upper face of the seat support 52. The present invention is not limited to this embodiment, and the seat support 52 may not have the object container 52c. For example, the entire upper face of the seat support 52 may be flat.

In the embodiment above, when the seat base 51 is in the inverted orientation P2, the upper face of the seat support 52 is flush with the opposite face 51b. The present invention is not limited to this embodiment, and when the seat base 51 is in the inverted orientation P2, the upper face of the seat support 52 and the seating face 51a may have a step therebetween.

The seat support 52 may include: right and left side plates disposed on respective laterally outer side in the seat support 52; a front plate extending between a front end portion of the left side plate and a front end plate of the right side plate; and a rear plate extending between a rear end portion of the left side plate and a rear end portion of the right side plate. In this case, the right and left side plates, the front plate and the rear plate may define the object container.

In the embodiment above, when the seat base 51 is in the inverted orientation P2, the angle between the upper face of the seat support 52 and the opposite face 51b is approximately 180 degrees. The present invention is not limited to this embodiment, and when the seat base 51 is in the inverted orientation P2, the angle between the upper face of the seat support 52 and the opposite face 51b may be any angle equal to or more than 90 degrees. For example, when the seat base 51 is in the inverted orientation P2, the angle between the upper face of the seat support 52 and the opposite face 51b may be approximately 120 degrees. In this case, swing of the seat base 51 is stopped only by the bracket 51e being brought into contact with the transversal frame 42a. In other words, a front or rear end portion of the seat base 51 in the inverted orientation P2, which portion is on a side of the axis A1 in the front-rear direction (for example, the rear end portion in FIG. 6) is not in contact with the front face of the seat support 52. In the present embodiment, the seating face 51a in the inverted orientation P2 faces downward and forward.

In the embodiment above, the utility vehicle was shown as an example of the work vehicle. The present invention is not limited to this embodiment, and is applicable to other work vehicles, such as combine harvester, tractor, rice transplanter, rice direct seeder, corn harvester, potato harvester, carrot harvester, sugarcane harvester, and construction work vehicle.

The features and arrangements disclosed in the embodiments above (including other embodiments; the same applies hereinafter) can be used in combination with the features and arrangements disclosed in other embodiments, as long as such combination does not cause inconsistency. In addition, the embodiments disclosed herein are only for the purpose of examples, and the embodiments of the present invention are not limited to those disclosed herein. The embodiments of the present invention can be suitably modified within the scope that does not deviate from the purpose of the present invention.

The present invention is applicable to a work vehicle and a seat arrangement.

What is claimed is:

1. A work vehicle comprises a body with a seat arrangement for an occupant to seat on,
the seat arrangement comprising:
a seat base; and
a seat support supporting the seat base,
wherein the seat base is swingable about an axis which is located in a front part or a rear part of the seat base and extends in a width direction of the seat base, the seat base is swingable between a use orientation in which a seating face of the seat base faces upward and an inverted orientation in which the seating face of the seat base faces downward, and
wherein with the seat base in the inverted orientation, an upper portion of the seat support is exposed.

2. The work vehicle according to claim 1,
wherein the seat base comprises:
an opening for ventilation in an end portion on a side opposite to a position of the axis in a front-rear direction; and
a bracket above the opening of the seat base in the inverted orientation, and
wherein swing of the seat base is limited by the bracket being brought into contact with the body.

3. The work vehicle according to claim 1,
wherein the seat base has an end portion on a side of the axis in a front-rear direction, and
wherein swing of the seat base is limited by the end portion of the seat base being brought into contact with the seat support.

4. The work vehicle according to claim 1,
wherein the seat base has an opposite face which is opposite to the seating face,
wherein in the use orientation, the seat base is mounted on an upper face of the seat support, and
wherein in the inverted orientation, the upper face of the seat support is flush with the opposite face.

5. The work vehicle according to claim 1, wherein the seat support comprises an object container receding downward from an upper face of the seat support.

6. The work vehicle according to claim 1, further comprising an occupant section for passengers,
wherein the occupant section comprises:
a driver’s seat for a driver; and
a rear seat, as the seat arrangement, rearward of the driver’s seat, and
wherein the rear seat has a width at least twice a width of the driver’s seat.

7. A seat arrangement comprising:
a seat base for an occupant to seat on; and
a seat support supporting the seat base,
wherein the seat base is swingable about an axis which is located in a front part or a rear part of the seat base and extends in a width direction of the seat base, the seat base is switchable between a use orientation in which a seating face of the seat base faces upward and an inverted orientation in which the seating face of the seat base faces downward, and
wherein with the seat base in the inverted orientation, an upper portion of the seat support is exposed.
